(19) United States
(12) Patent Application Publication
(10) Pub. No.: US 2005/0043655 A1
(43) Pub. Date: Feb. 24, 2005

(54) Back support device

(76) Inventor: David Schenck, Jacksonville, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/643,600

(22) Filed: Aug. 18, 2003

(51) Int. Cl. A61H 23/02

(52) U.S. Cl. 601/15; 601/71

(57) ABSTRACT

A back support device for heating and stimulating the nerves of a user's back includes a belt having inner and outer coverings, a conformable heat transfer pad having inner and outer coverings joined to each other to form discrete sections that are filled with a particulate heat retention material, a heating element adjacent the outer side of the heat transfer pad, a back support plate adjacent the outer side of the heating element, and at least one nerve stimulator. The nerve stimulator may be formed of a plurality of vibrators, a transcutaneous nerve stimulator, or both. A battery and a controller power and control the heating element and the nerve stimulator. The heat transfer pad and back support plate are preferably of approximately the same shape and size, while the heating element is of a smaller size, permitting the vibrators to contact the heat transfer pad.

### BACKGROUND OF THE INVENTION

(1) Field of the Invention

The present invention relates to a back support device that is used to support a user's back while simultaneously providing relief from backache through the application of a combination of heat and nerve stimulation.

(2) Description of the Prior Art

Back supports and belts that provide heat to a user's back are known in the prior art as exemplified by U.S. Pat. No. 4,702,235 to Hong; U.S. Pat. No. 5,062,414 to Grim; U.S. Pat. No. 5,928,275 to Yates et al.; U.S. Pat. No. 5,891,189 to Payne, Jr.; and U.S. Pat. No. 5,378,225 to Chatman, Jr. et al. This latter patent also discloses that elements can be incorporated into the belt to generate vibrations to massage the user's back.

While numerous prior art back support designs are known, a support that is suitable for users of differing physical dimensions and postures is not available. Back supports are normally comprised of a belt or strap that is attached around the user's midriff. The central part of the belt is positioned against the user's lumbar region and normally includes a back support plate to provide support to the user's back. When the belt is also used to apply heat to the user's lumbar region, an electrical heating element is normally positioned inside the support plate.

The shape of the lumbar region differs from user to user, and also changes during movement. As a result, merely positioning a support plate and/or heating element adjacent the user's back will result in areas of high and low pressure, causing discomfort and a lack of effective support and heat application. In an attempt to alleviate these problems, the prior art has suggested the inclusion of a cushioning pad between the heating element and the user's back. Cushions or pads of foam, gel and air have been proposed.

However, while these problems have been somewhat alleviated by prior art pads, there is still a need for a pad that will better conform to the user's back. Moreover, since the pad is interposed between the heat source and the user's back, the pad should also effectively transfer heat. Also, to conserve energy, particularly battery power, while providing relief over an extended period, it would be desirable if the pad retained heat after the heating element was disconnected.

It is also known that back pain as well as stress, can also be relieved by nerve stimulation, e.g., by vibrating or massaging the lumbar area. However, when an attempt is made to combine a back support with a heat source and a vibration means in a lumbar belt, the effectiveness of the individual elements is impaired by the presence of the other elements. For example, a back support plate, or a pad such as an air cushion, may absorb the vibrations of the vibration means before the vibrations reach the user's back. Thus, there is a continuing need for a back support or lumbar belt that is capable of providing back support along with heat and vibration to the user's back.

### SUMMARY OF THE INVENTION

The present invention addresses these needs by providing a back support belt that includes a heating element and a nerve stimulation means, with the belt components being of a composition and configuration such that the user's lumbar region is supported while heat and nerve stimulation are effectively transmitted.

Generally, the back support device of the present invention is comprised of a belt to fit around the user's midriff, a heating element, a heat transfer pad between the heating element and the inside of the belt, a back support plate on the exterior of the heating element, and a nerve stimulator, i.e., a plurality of vibrators positioned around the outer periphery of the heating element on the outer side of the heat transfer pad, or a transcutaneous nerve stimulator to impart stimulation to the nerves. The device also includes a battery to power the heating element and nerve stimulator, and a controller to control the activation of the heating element and nerve stimulator.

More specifically, the back support belt is comprised of a center section with opposed integral end sections having a width less than the width of the center section. The belt has inner and outer coverings, which may be of fabric or other flexible material, together forming an interior chamber to receive other components of the device. In the preferred embodiment, the center section is of a length sufficient to extend across the back of the average user, and a width sufficient to extend from the top to bottom of the lumbar region.

The ends of the belt include fasteners permitting releasable attachment of the belt at various lengths to accommodate different users. For example, a first end of the belt may include a loop of metal or plastic sized for insertion of the second end of the belt. The second end of the belt may include hook-and-loop fastener sections to secure the belt ends together. Alternatively, the belt ends may be secured by a buckle or by mating hook-and-loop sections. The belt second end may also include scored sections so that the belt can be shortened, if desired.

The heating element is preferably a resistance heating element comprised of a wire, that is normally coiled in a serpentine fashion within a planar area. The ends of the wire loop are connected in a circuit with a battery. When the circuit is closed, current flows through the loop, causing the wire to heat due to resistance to the current flow. Since the wire is of a small diameter, the wire rapidly cools when the circuit is opened. The circuit planar area may be of different shapes, e.g., rectangular or oval, and generally covers a given area less than the area of the belt center section. If desired, the wire coil can be embedded in a sheet of plastic or other material.

The heat transfer pad of the present invention is uniquely designed to provide comfort to the user, while retaining and uniformly transferring heat from the heating element to the user's back. The pad is comprised of a flexible covering or pouch and encloses a particulate or granular material. This material may be a carbon-based material, such as charcoal. However, to best achieve the objectives of the present invention, the material is granular or particulate lava rock, preferably having an average particle size of up to about 10 mm, and even more preferably an average particle size of from about 2 to about 5 mm.

In order to evenly distribute the particulate material within the pad, the pad is preferably divided into chambers or sections by sewing or otherwise joining the inner and outer sheets of the pad covering to each other. In a preferred embodiment, the inner and outer sheets are joined along parallel lines aligned with the longitudinal axis of the belt to form tubular pad sections, each filled with particulate heat transfer material. With this configuration, the heat transfer pad is readily conformable to the shape of the backs of different users, or a single user during movement. The pad may be of different shapes, e.g., rectangular or oval. Preferably, the pad has the same peripheral shape as the heating element, but is of a greater dimension. Thus, when the heating element is placed against the center of the heat transfer pad, the heat transfer pad will extend outwardly beyond the periphery of the heating element.

Back support plates are per se known in the prior art and suitable materials for their construction will be apparent to one skilled in the art. Such plates are of a generally rigid material, such as a sheet of plastic or metal, that provides dimensional support to the user's back. In the present invention, the plate may be of various shapes, e.g., rectangular or oval, and will preferably have approximately the same dimensions as the heat transfer pad.

Vibrators or vibrating motors are also per se known in the prior art. Generally, these vibrators are electrical devices that produce a rapid oscillating or reciprocating motion when an electric current is applied. One example of a vibrator is a small electric DC motor having an offset weight. When energized, the motor vibrates, transmitting the vibration to material in contact with the motors. Another example is a linear motor that causes a component, such as a solenoid, to move rapidly back and forth along a linear path as a circuit is opened and closed.

In one embodiment of the present invention, a plurality of vibrators are positioned inside the belt around the outer periphery of the heating element, but within the periphery of the heat transfer pad. Thus, vibrations are transferred to the heat transfer pad without interference from the heating element. Further, due to the construction of the heat transfer pad, these vibrations are uniformly distributed and transferred to the user's back.

The vibrators may be positioned on the inside or even the outside surface of the back support plate. Preferably, however, the back support plate includes a plurality of vibrator receiving openings spaced outside of the periphery of the heating element, but inside the periphery of the back support plate and the heat transfer pad, with the vibrators being mounted within the back support plate openings. In this manner, the vibrators are in direct contact with the heat transfer pad, providing the greatest transfer of the vibrations and resulting massaging action to the user.

The heating element and vibrators are in an electrical circuit with a battery which serves as the power source for the present device. Preferably, the battery is a rechargeable battery. The battery may be housed within the belt, attached to the exterior of the belt, e.g., within a belt pocket, or joined to the belt by a connecting cord, permitting the battery to be carried in the user's pocket.

The heating element, vibrators and battery are in a circuit with a controller, which includes switches to open and close circuits that include the heating element and each of the vibrators. The controller may also include rheostats in one or more of the circuits to control the amount of current flowing to heating element or a given vibrator. Thus, the controller enables the user to independently control the heating element and each of the vibrators. As a result, heat and vibration can be applied independently or together. Also, the vibrators can be energized in one or more sequential patterns.

Instead of, or in addition to, the vibrators described above the device may include a transcutaneous electrical nerve stimulator, commonly called a TENS unit or TENS device. Basically, the TENS unit is comprised of a controller and a pair of electrode pads that are adapted to be attached to the user's skin at the area to be treated, with the pads and controller being connected by electrical cables. A pulsating electrical current is transmitted to the electrodes to stimulate the area. The frequency and intensity of the electrical pulses can be controlled through the controller previously described. For this purpose, the controller can include attachment means for securing electrode cables that extend to the electrode pads as well as connections to the heating element.

The battery can also be in an electrical circuit with a pressure sensitive switch that is positioned on the interior of the belt. When the belt is tightened around the user, this switch is closed, permitting current to flow from the battery to the heating element and vibrators. However, when the belt is removed, the switch opens the circuit to the battery, de-energizing the device.

### BRIEF DESCRIPTION OF THE DRAWINGS

FIG. 1 is a side view of the outer side of the back support device with sections cut away to reveal interior components.

FIG. 2 is a side view of the back support plate.

FIG. 3 is a side view of the heat transfer pad with a section cut away to reveal the interior components.

FIG. 4 is a side view of the inner side of the back support device.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

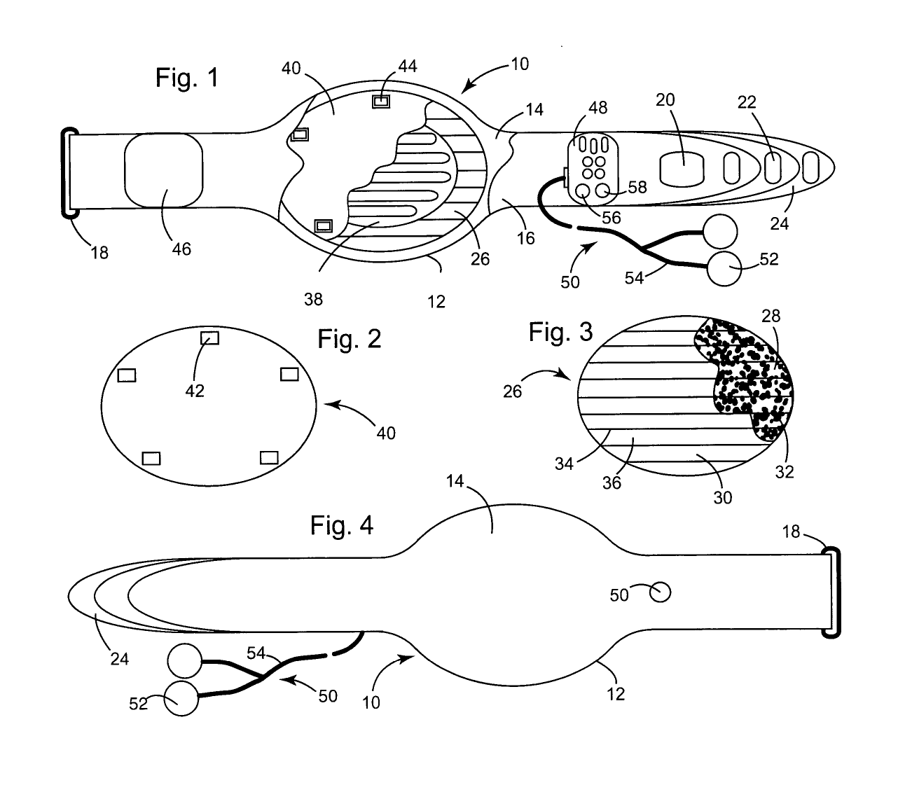

As best illustrated in FIG. 1, the back support device, generally 10, is comprised of a belt 10 having an inner covering 12 and an outer covering 16 that are joined along their outer edges to form an interior cavity for receiving other components. The outer ends of belt 10 are releasibly attached with a loop 18 and mating hook-and-loop fasteners 20 and 22 joinable around loop 18. One of the outer ends of belt 10 includes scored tips 24 that can be detached, e.g., by cutting, to shorten belt 10 to accommodate a user with a smaller waist.

Heat transfer pad 26, also illustrated in FIG. 4, is positioned adjacent inner cover 14. Pad 26 is formed of an inner covering 28 and an outer covering 30 that are joined along their outer edges to form a cavity for holding a particulate heat transfer material 32, e.g., crushed lava rock. Coverings 28 and 30 are also joined to each other along parallel lines 34 to form parallel tubular pockets 36 that are filled with heat transfer material 32. As a result, material 32 will be spread across pad 26, instead of falling to the bottom. Pad 26, as shown in the preferred embodiment, has a generally oval outer periphery of a given diameter.

Resistance heating element 38 positioned adjacent the outer side of pad 26 is comprised of a wire coiled in a serpentine fashion and carried on a sheet of plastic or other nonconductive material. The outer periphery of heating element 38 is smaller than the outer periphery of pad 26, so that pad 26 extends beyond heating element 38.

Back support plate 40, also illustrated in FIG. 3, is a generally rigid oval plate positioned on the exterior of heating element 38 and overlaying pad 26. Preferably, plate 40 and pad 26 are of approximately the same size and shape. Plate 40 includes a plurality of openings 42 to receive vibrators 44. Vibrators 44 are spaced outside of the outer periphery of heating element 38 and adjacent pad 26, so that vibrations of vibrators 44 are transferred directly to pad 26 and evenly transmitted by particulate material 32 across the user's back.

Rechargeable battery 46 is attached to belt 12 and is joined through wiring (not shown) into circuits with heating element 38 and vibrators 44. Controller 48, which may be fixedly or removably attached to belt 12, is also in communication with heating element 38 and vibrators 44 to selectively energize element 38 and vibrators 44. Battery 46 is also in circuit with pressure sensitive switch 50, which opens to de-energize the circuit when the user removes belt 12.

Device 10, as illustrated in the preferred embodiment, also includes transcutaneous nerve stimulation electrodes, generally 50, comprised of a pair of electrode pads 52 and electrical cables 54 to attach pads 52 to controller 48. While the preferred embodiment includes both vibrators 44 and stimulator 50, other embodiments of the invention can include only one of these nerve stimulators. Controller 48 includes a pulse control 56 and a frequency control 58 for controlling the intensity and frequency of impulses sent to pads 52.

Certain modifications and improvements will occur to those skilled in the art upon reading of the foregoing description. It should be understood that all such modifications and improvements have been deleted herein for the sake of conciseness and readability but are properly within the scope of the following claims.

1. A back support device for heating and vibrating a user's back comprising:
a) a belt having an inner covering and an outer covering;
b) a comformable pad of heat retention material, said pad having an inner side adjacent said belt inner covering, an outer side, and an outer pad periphery;
c) a heating element having an inner side adjacent the outer side of said heat retention pad, an outer side, a heating element periphery smaller than said pad periphery;
d) a back support plate adjacent the outer side of said heating element;
e) a plurality of vibrators between said inner and outer coverings, said vibrators being positioned beyond said heating element periphery, but within said pad periphery;
f) a battery in a circuit with said heating element and said vibrators; and
g) a controller adapted to control current to said heating element and said vibrators.

2. The device of claim 1, wherein said back support plate includes openings and said vibrators are positioned within said openings.

3. The device of claim 1, wherein said belt has first and second attachable end sections of given widths and a center section having a width greater than the widths of said ends, said pad, heating element and back support plate being positioned in said center section.

4. The device of claim 1, wherein said vibrators are independently activatable in a predetermined sequence by said controller.

5. The device of claim 1, further including a pressure activated switch on said belt in circuit with said battery, said pressure activated switch being deactivated when said belt is not worn by a user.

6. The device of claim 1, wherein said heat retention material is crushed lava rock.

7. The device of claim 1, wherein said heat transfer pad inner and outer coverings are joined to each other to form discrete sections, each section being filled with a heat retention material.

8. The device of claim 1, wherein said belt has a longitudinal axis, and said pad coverings are joined at parallel lines to form tubular sections, each of said tubular sections being filled with said heat retention material, said parallel lines being parallel to the longitudinal axis of said belt.

9. The device of claim 1, wherein said heat retention material has an average particle size of up to 10 mm.

10. A back support device for heating and vibrating a user's back comprising:
a) a belt having an inner covering and an outer covering;
b) a comformable heat transfer pad, said pad having inner and outer coverings joined to each other to form discrete sections, each discrete section being filled with a particulate heat retention material, said pad having an inner side adjacent said belt inner covering, an outer side;
c) a heating element having an inner side adjacent the outer side of said heat retention pad, an outer side;
d) a back support plate adjacent the outer side of said heating element;
e) transcutaneous nerve stimulator electrodes;
f) a battery in a circuit with said heating element, said stimulator electrodes; and
g) a controller adapted to control current flow to said heating element and said stimulator electrodes.

11. The device of claim 10, wherein said transcutaneous nerve stimulation electrodes include a pair of electrode pads joined to said controller by electrical cables, and said controller includes means for controlling the frequency and intensity of electrical impulses sent to said electrode pads.

12. A back support device for heating and vibrating a user's back comprising:
a) a belt having an inner covering and an outer covering;
b) a comformable heat transfer pad, said pad having inner and outer coverings joined to each other to form discrete sections, each discrete section being filled with a particulate heat retention material, said pad having an inner side adjacent said belt inner covering, an outer side;
c) a heating element having an inner side adjacent the outer side of said heat retention pad, an outer side;
d) a back support plate adjacent the outer side of said heating element;
e) a transcutaneous nerve stimulator;
f) a plurality of vibrators;
g) a battery in a circuit with said heating element, said transcutaneous nerve stimulator, and said vibrators; and
h) a controller adapted to control current flow to said heating element, said transcutaneous nerve stimulation electrodes, and said vibrators.

13. The device of claim 12, wherein said heat transfer pad has an outer periphery and said heating element has an outer periphery smaller than said pad periphery.

14. The device of claim 12, wherein said vibrators are positioned beyond said heating element periphery, but within said pad periphery;

15. The device of claim 12, wherein said transcutaneous nerve stimulation electrodes include a pair of electrode pads joined to said controller by electrical cables, and said controller includes means for controlling the frequency and intensity of electrical impulses sent to said electrode pads.

16. The device of claim 12, wherein said belt has first and second attachable end sections of given widths and a center section having a width greater than the widths of said ends, said pad, heating element and back support plate being positioned in said center section.

17. The device of claim 12, wherein said vibrators are independently activatable in a predetermined sequence by said controller.

18. The device of claim 12, further including a pressure activated switch on said belt in circuit with said battery, said pressure activated switch being deactivated when said belt is not worn by a user.

19. The device of claim 12, wherein said belt has a longitudinal axis, and said pad coverings are joined at parallel lines to form tubular sections, each of said tubular sections being filled with said heat retention material, said parallel lines being parallel to the longitudinal axis of said belt.

20. The device of claim 12, wherein said heat retention material has an average particle size of up to 10 mm.
